(19) United States
(12) Patent Application Publication
(10) Pub. No.: US 2026/0017750 A1
(43) Pub. Date: Jan. 15, 2026

(54) EVS BASED CIS VIDEO FRAME INTERPOLATION AND SMART REGION OF INTEREST

(71) Applicant: OmniVision Technologies, Inc., Santa Clara, CA (US)

(72) Inventors: Tiejun Dai, Santa Clara, CA (US); Bo Mu, San Jose, CA (US); Lihang Fan, Sunnyvale, CA (US); Jin-Long Zhang, Santa Clara, CA (US); Dennis Lee, San Jose, CA (US); Cheng-Pin Lin, Saratoga, CA (US)

(21) Appl. No.: 19/266,276

(22) Filed: Jul. 11, 2025

Related U.S. Application Data
(60) Provisional application No. 63/669,735, filed on Jul. 11, 2024.

(51) Int. Cl. G06T 3/4007; H04N 25/77

(52) U.S. Cl. CPC G06T 3/4007; H04N 25/77

(57) ABSTRACT

A CMOS image sensor generates a key frame by reading pixel values of all pixels from an image sensor core and outputs the pixel values as a key frame. The sensor generates an interpolated frame by reading at least one pixel value from a pixel area of the image sensor core having at least one pixel identified by an event signal, interpolating between a corresponding portion of the key frame and the at least one pixel value to form an interpolated partial frame; and outputting the interpolated partial frame. The CMOS image sensor determines a region of interest (ROI) from the event signal and interleaves precharge of full frame rows of the image sensor core with precharge of ROI partial rows of the ROI; and interleaves readout of full frame pixel values from the full frame rows with readout of ROI pixel values from the ROI partial rows.

### RELATED APPLICATIONS

This application claims priority to U.S. Patent Application Ser. No. 63/669,735, titled “EVS based CIS Video Frame Interpolation and Smart Region of Interest,” filed Jul. 11, 2024, which is incorporated herein by reference in its entirety.

### FIELD

The present application is directed to image sensors and in particular to Event-based vision sensors.

### BACKGROUND

An EVS (Event-based Vision Sensor) realizes high-speed data output with low latency by limiting the output data to luminance changes from each pixel, combined with information on coordinates and time. With a focus on movement, they can be applied in a wide variety of fields. In EVS, the luminance changes detected by each pixel are filtered to extract only those that exceed the preset threshold value. This event data is then combined with the pixel coordinate, time, and polarity information before being output. Each pixel operates asynchronously, independently from any other. Each pixel detects luminance changes asynchronously and will output event data immediately. When multiple pixels produce events the arbitration circuit controls the output order based on the earliest-received event. In this way the sensor outputs events as they are generated, making it possible to only output necessary data at the microsecond order while keeping power consumption low.

### SUMMARY

One aspect of the present embodiments includes the realization that although a hybrid image sensor that combines Event-based Vision Sensor (EVS) and CMOS Image Sensor (CIS) where video frame interpolation (VFI) is implemented on EVS pixels has reduced power in the image sensor, is has high power requirement and long time calculation to convert EVS information into CIS information by optical flow, and therefore overall power consumption is high and the calculation time reduces its suitability for video capture. The present embodiment solve this problem by implementing an EVS based CIS VFI (also known as Event guided Low Power—ELP) that reduces overall power requirements (e.g., sensor chip and platform) and realizes real-time video frame interpolation. When an event signal is generated, at least one pixel value, corresponding to at least one pixel identified by the event signal, is read from the image sensor core and a partial frame is output by interpolating between a corresponding portion of a prior key frame and the at least one pixel value. When no event signals are detected (e.g., where there is no change in the captured scene), no pixel values are read from the image sensor core and an interpolated frame repeats a previous frame.

In certain embodiments, the techniques described herein relate to a method for event-based imaging and video frame interpolation on a complementary metal oxide semiconductor (CMOS) image sensor core, including: generating a key frame by reading pixel values of pixels from the image sensor core; and generating an interpolated event guided low power (ELP) frame by: reading pixel values from a pixel area of the image sensor core identified by an event signal; and interpolating between the pixel values and a corresponding portion of the key frame or between the portion of the key frame and a corresponding portion of a subsequent key frame to form an interpolated partial frame.

In certain embodiments, the techniques described herein relate to a method for event-based imaging with a complementary metal oxide semiconductor (CMOS) image sensor core and a region of interest (ROI), including: determining the ROI from at least one event signal generated by event driven circuitry of the image sensor core; and generating a key frame by: interleaving precharge of full frame rows of the image sensor core with precharge of ROI partial rows of the ROI; and interleaving readout of full frame pixel values from the full frame rows with readout of ROI pixel values from the ROI partial rows.

In certain embodiments, the techniques described herein relate to a complementary metal oxide semiconductor (CMOS) image sensor, including: an image sensor core having a plurality of image sensing pixels; event driven circuitry for generating an event signal indicating at least one pixel of the image sensor core having a changed pixel value; and a processor coupled with the image sensor core and implementing: a CMOS image sensor (CIS) reader for reading pixel values from the image sensing pixels of the image sensor core; a key frame generator for controlling the CIS reader to read pixel values to form a key frame; and a video frame interpolator for controlling the CIS reader to read pixel values of a pixel area corresponding to an event to form an interpolated frame based on a previous key frame and one of (a) the pixel values and (b) a subsequent key frame.

### BRIEF DESCRIPTION OF THE FIGURES

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a block diagram illustrating one example hybrid image sensor that implements EVS based CIS VFI, in embodiments.

FIG. 2 shows a key frame readout with rolling shutter pixel readout periods that occur for each row of image sensor core and an interpolation frame readout with rolling shutter interpolation periods for each row of image sensor core.

FIG. 3 is a schematic diagram illustrating a key frame mode that invokes key frame generator to generate MIPI key frame output during key frame readout and an interpolation frame mode that invokes VFI generator to generate MIPI interpolation frame output of during interpolation frame readout, in embodiments.

FIG. 4 shows an image captured by hybrid image sensor of FIG. 1 illustrating one example smart ROI generated by ROI tracker of hybrid image sensor, in embodiments.

FIG. 5 shows another image captured by hybrid image sensor of FIG. 1 illustrating one example smart ROI determined by ROI tracker of hybrid image sensor, in embodiments.

FIG. 6 is a flowchart illustrating one example method for EVS based CIS FVI, in embodiments.

FIGS. 7A, 7B, 8A, 8B, 9A, 9B, and 10A are schematic representations of a portion of the pixel array of the image sensor core illustrating a plurality of events generated by event driven circuitry and corresponding readout areas of pixel values by CIS reader, in embodiments.

FIG. 10B is a timing chart illustrating example staggering of precharge and readout operations for rows of image sensor core for both full frame and ROI area of FIG. 10A, in embodiments.

FIG. 11 is a schematic diagram illustrating one example staggered key frame mode that includes staggered key readout frame and a corresponding MIPI staggered frame output, in embodiments.

FIG. 12 is a schematic diagram showing a plurality of staggered key readout frames of FIG. 11 where each staggered key readout frame includes multiple example CIS ROI frames, in embodiments.

FIG. 13 is a schematic diagram illustrating one example staggered interpolation mode of hybrid image sensor of FIG. 1, in embodiments.

FIG. 14 is a schematic diagram illustrating a sequence of staggered key readout frames and staggered interpolation readout frames where one staggered interpolation readout frame includes multiple ROI readout frames.

FIG. 15 is a flowchart illustrating one example method for combined CIS VFI and Staggered ROI, in embodiments.

### DETAILED DESCRIPTION OF THE EMBODIMENTS

In the following description, certain specific details are set forth in order to provide a thorough understanding of various disclosed embodiments. However, one skilled in the relevant art will recognize that embodiments may be practiced without one or more of these specific details, or with other methods, components, materials, etc.

Unless the context requires otherwise, throughout the specification and claims which follow, the word “comprise” and variations thereof, such as, “comprises” and “comprising” are to be construed in an open, inclusive sense that is as “including, but not limited to.”

Reference throughout this specification to “one implementation” or “an implementation” or “one embodiment” or “an embodiment” means that a particular feature, structure or characteristic described in connection with the embodiment is included in at least one implementation or embodiment. Thus, the appearances of the phrases “one implementation” or “an implementation” or “in one embodiment” or “in an embodiment” in various places throughout this specification are not necessarily all referring to the same implementation or embodiment. Furthermore, the particular features, structures, or characteristics may be combined in any suitable manner in one or more implementations or one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

### Video Frame Interpolation

Low power is critical for video capture, especially for applications like a mobile phone, for augmented reality and/or virtual reality, and so on. A prior art CMOS Image Sensor (CIS) reads out all pixel information for every output frame, irrespective of whether the is any change in the captured information. Prior art CIS therefore consumes high power with and the output data includes much redundant information. A prior art hybrid EVS-CIS image sensor (e.g., Omnivision's OV50N) uses Event-based Vision Sensor (EVS) Video Frame Interpolation (VFI) to reduce power by reading only changed pixel values from the image sensor as indicated by EVS event signals. With EVS VFI, interpolation is based directly on the event signals and intermediate frames are generated between key frames. However, since EVS VFI generates full intermediate frames, while power is saved reading the data from the image sensor core, the image sensor processor still interpolates the entire frame to generate the video output. Thus, EVS VFI consumes high platform power for calculations that require a significant amount of time to convert EVS information (e.g., changed pixel values) to full-frame CIS information using optical flow in the platform. Thus, overall system power consumption for EVS VFI remains high. Further, the significant time for the interpolation calculations means that EVS VFI cannot support real-time video.

The present embodiments solve this problem by implementing EVS based CIS VFI (also known as Event guided Low Power-ELP), which reduces overall power requirements by also reducing the necessary calculation time for VFI and therefore realizes real time VFI.

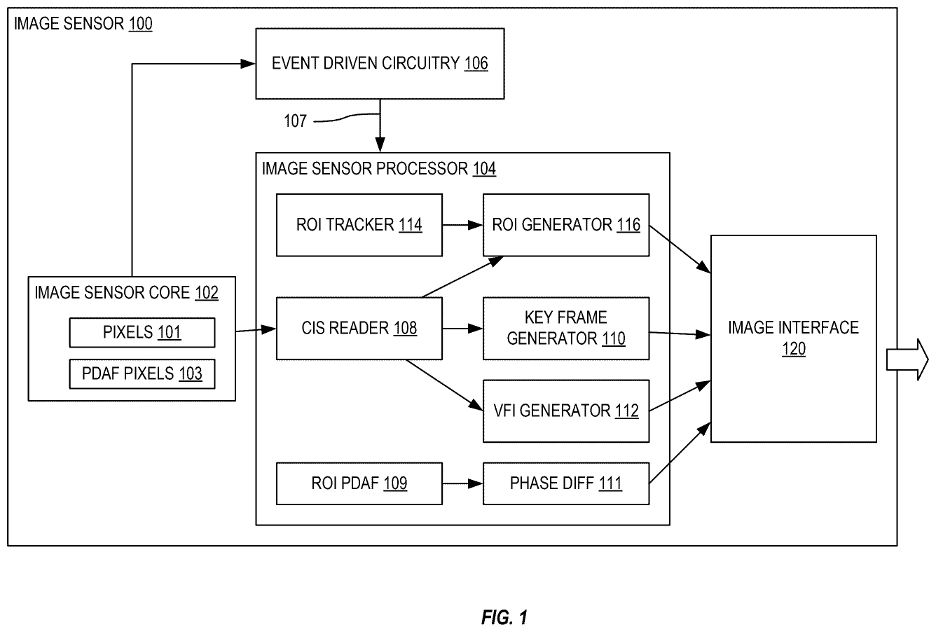

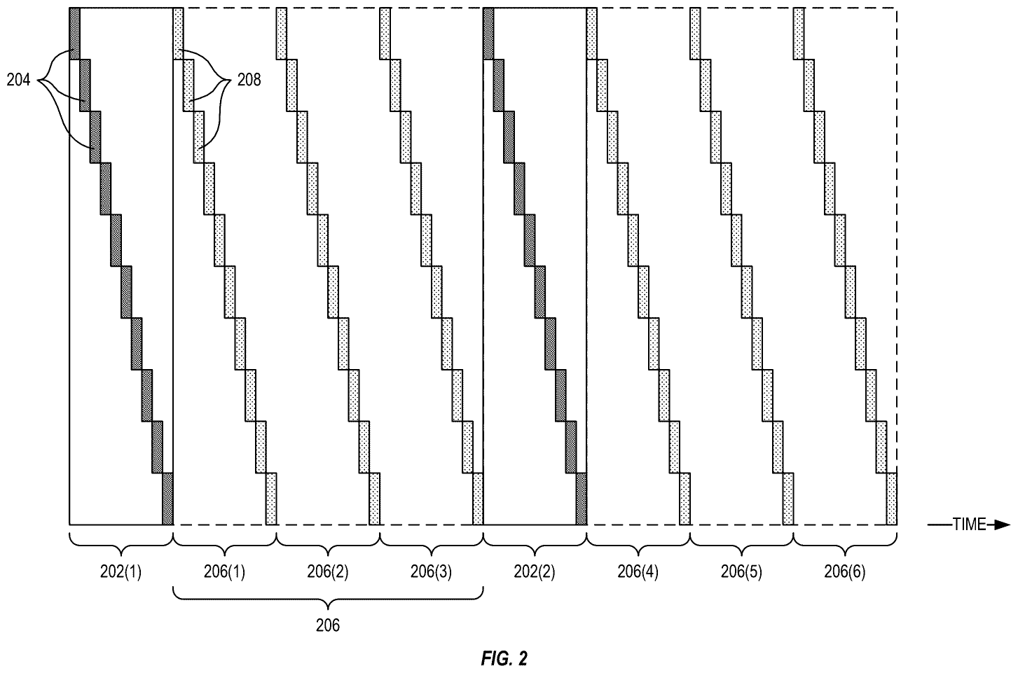

FIG. 1 is a block diagram illustrating one example hybrid image sensor 100 that implements EVS based CIS VFI, in embodiments. FIG. 2 is a schematic diagram illustrating example operation of hybrid image sensor 100 of FIG. 1, in embodiments. FIGS. 1 and 2 are best viewed together with the following description.

Hybrid image sensor 100 includes an image sensor core 102 with an array of image sensing pixels 101, an image sensor processor 104 coupled with image sensor core 102 to implement an event driven circuitry 106, a CIS reader 108, a key frame generator 110, a VFI generator 112, a region-of-interest (ROI) tracker 114, an ROI generator 116, and an image interface 120 for outputting image frames. Image sensor core 102 is a complementary metal oxide semiconductor (CMOS) image sensor core, for example. However, hybrid image sensor 100 operates with reduced power, as compared to a conventional CMOS image sensor, and without imposing additional processing on an imaging platform using image sensor 100, as done by conventional hybrid EVS VFI image sensors. Event driven circuitry 106 detects pixel values of image sensor core 102 that change and generates an event signal 107 to identify a position of the changed pixel value. CIS reader 108 is controlled to read pixel values of image sensing pixels 101 of image sensor core 102 and one or more of key frame generator 110, VFI generator 112, and ROI generator 116 are invoked to generate Mobile Industry Processor Interface (MIPI) frame output for image interface 120.

FIG. 2 shows a key frame readout 202 with rolling shutter pixel readout periods 204 that occur for each row of image sensor core 102 and an interpolation frame readout 206 with rolling shutter interpolation periods 208 for each row of image sensor core 102. However, as described in detail below, CIS VFI is based on EVS and is performed only on certain pixels read out from image sensor core 102 as identified by event signals 107 generated by event driven circuitry 106. In the example of FIG. 2, key frame readout 202 (generated by key frame generator 110) is followed by three interpolation frame readouts 206 (generated by VFI generator 112) to give a four times increase in output frame rate; however, different frame rates with other numbers of interpolation frames may be used without departing from the scope hereof. As shown in FIG. 2, key frame readout 202 and interpolation frame readout 206 are temporarily spaced.

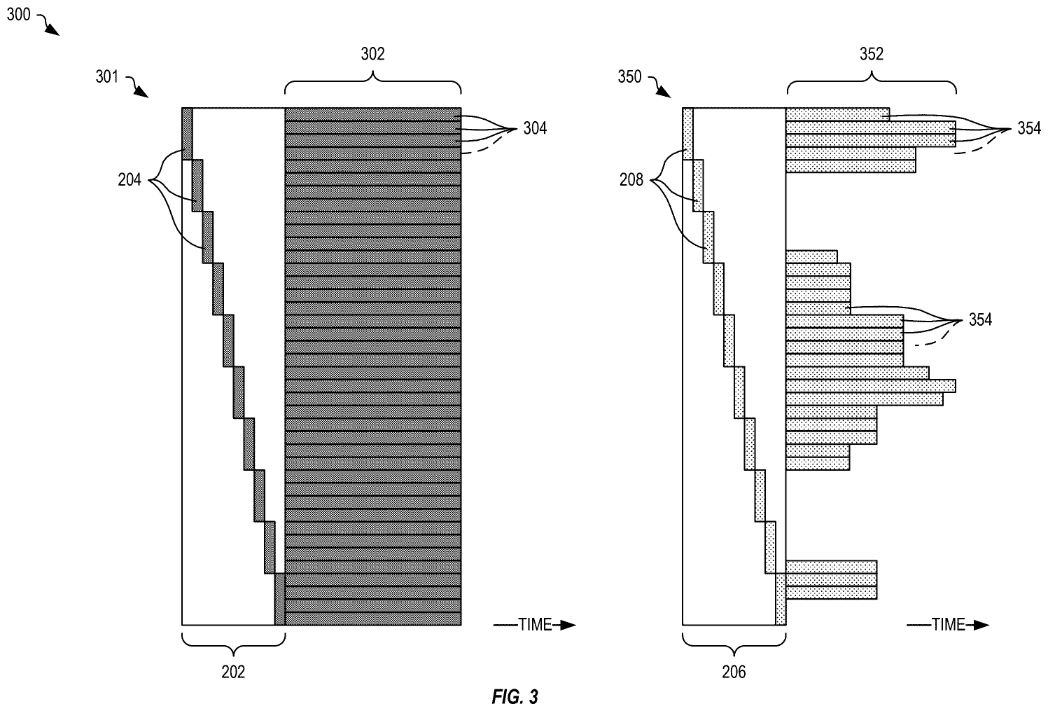

FIG. 3 is a schematic diagram 300 illustrating a key frame mode 301 that invokes key frame generator 110 to generate MIPI key frame output 302 during key frame readout 202 and an interpolation frame mode 350 that invokes VFI generator 112 to generate MIPI interpolation frame output 352 of during interpolation frame readout 206, in embodiments. MIPI key frame output 302 includes key frame data packets 304 for all pixels of image sensor core 102 and thereby includes full image data. MIPI interpolation frame output 352 includes interpolation frame data packets 354 corresponding to event signals 107 generated by event driven circuitry 106 for pixels values that have changed. Interpolation may not occur for certain pixel areas that do not have pixel values that have changed. MIPI key frame output 302 and MIPI interpolation frame output 352 collectively represent video output of hybrid image sensor 100. Although these examples illustrate operation with a rolling shutter image sensor, the disclosed techniques may also be applied to a global shutter (GS) image sensor.

As shown in FIG. 3, MIPI interpolation frame output 352 of interpolation frame data packets 354 are only generated when event driven circuitry 106 indicates a pixel value has changed. During interpolation frame readout 206, CIS reader 108 only reads pixel values from image sensor core 102 when event driven circuitry 106 generates event signal 107 to indicate that the pixel value has changed, and thus VFI occurs only for the read pixel values. Accordingly, MIPI interpolation frame output 352 only includes interpolation frame data packets 354 corresponding to pixel values read from image sensor core 102 in response to detected events. That is, MIPI interpolation frame output 352 may not include interpolation frame data packets 354 for rolling shutter interpolation periods 208 that do not correspond to event signals 107.

Advantageously, during interpolation frame mode 350, CIS reader 108 does not read all pixels of every frame and VFI is not performed where pixel values are unchanged. Therefore, pixel value read times and associated power required for CIS VFI is reduced as compared to read times and required power for conventional full frame CIS readout and VFI. Accordingly, power required for EVS driven CIS VFI is reduced as compared to EVS VFI (e.g., ELP) since EVS driven CIS VFI processes a limited region of CSI data as compared full frame CSI processing and EVI processing of conventional EVS VFI. By processing a subset of the image, less power is required as compared to processing the full image. Where power saving is not a concern, full frame EVS VFI may be implemented whereby blocks of the image for processing are not identified. In another approach, EVS VFI may be considered as an unconditional blind interpolation whereas EVS driven CIS VFI may be considered as conditioned interpolation. Since EVS driven CIS VFI processes a smaller region as compared to the unconditional blind operation of EVS VFI, power is saved. Thus, using a combination of CIS and EVS in a more targeted manner rather than the full EVS approach leads to power savings due to reduced operations and more efficient processing.

### Smart Region of Interest

Conventionally, tracking movement of an object in an image stream is performed external to the image sensor, such as by an image processor and/or external computer. For example, the image processor may use one or more algorithms to process image frames received from the image sensor to identify an object moving in the captured images.

For mobile applications, such as a smart phone, image sensor goals include both high spatial resolution (e.g., 12.5M pixels or “4K”), high temporal resolution (e.g., a high frame rate) for video capture, and low power consumption. For normal CIS, the combination of high resolution and high frame rate results in a high power consumption. Advantageously, as compared to EVS VFI, hybrid image sensor 100 implements CIS VFI, which may reduce both sensor and platform power requirements; however, frame rate cannot be increased without a significant increase in power, since CIS VFI alone cannot increase frame rate.

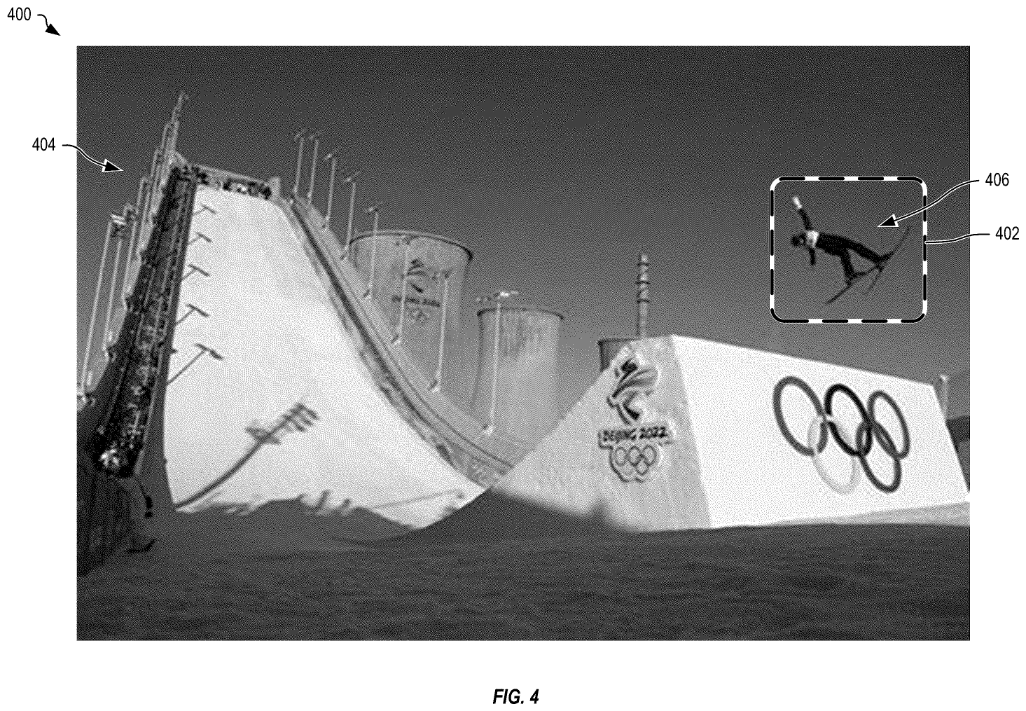

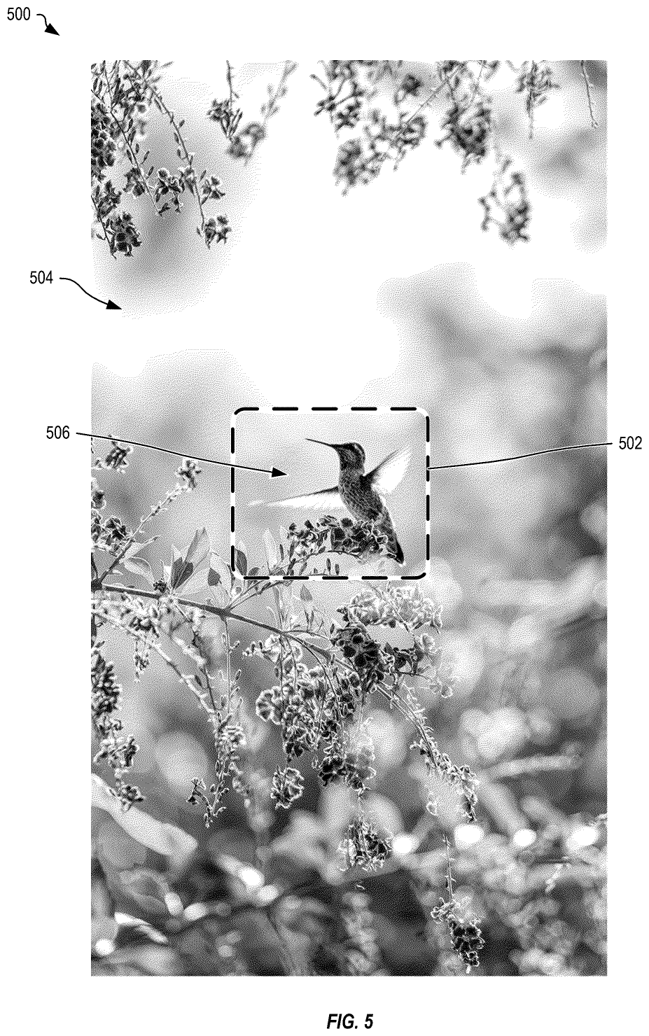

FIG. 4 shows an image 400 captured by hybrid image sensor 100 of FIG. 1 illustrating one example smart ROI 402 generated by ROI tracker 114 of hybrid image sensor 100, in embodiments. FIG. 5 shows another image 500 captured by hybrid image sensor 100 of FIG. 1 illustrating one example smart ROI 502 determined by ROI tracker 114 of hybrid image sensor 100, in embodiments. For clarity of illustration, smart ROI 402 and 502 are indicated in dashed line within images 400 and 500, however, smart ROI 402 and 502 are defined relative to a pixel array of image sensor core 102. In these examples, ROI 402 and 502 each include a moving object that benefits from an increased frame rate of capture as compared to a frame rate of backgrounds 404 and 504, respectively, of images 400 and 500 that do not contain moving objects. FIGS. 1, 4 and 5 are best viewed together with the following description.

Hybrid image sensor 100 captures backgrounds 404 and 504 at a low frame rate (e.g., a frame rate of key frame readout 202, such as 30 fps) and captures smart ROI 402 and 502 at a higher frame rate (e.g., a combined frame rate of key frame readout 202 and interpolation frame readout 206, such as 120 fps or higher). In the example of FIG. 4, ROI tracker 114 causes smart ROI 402 to track a target 406 (e.g., a free-style skier) and updates the size and position of smart ROI 402 in real-time as target 406 moves relative to the field of view captured by hybrid image sensor 100. In the example of FIG. 5, a target 506 (e.g., a hovering hummingbird) does no change location, and therefore a location of smart ROI 502 does not change, however, smart ROI 502 is generated in response to movement of parts of target 506 (e.g., the wings of the hummingbird).

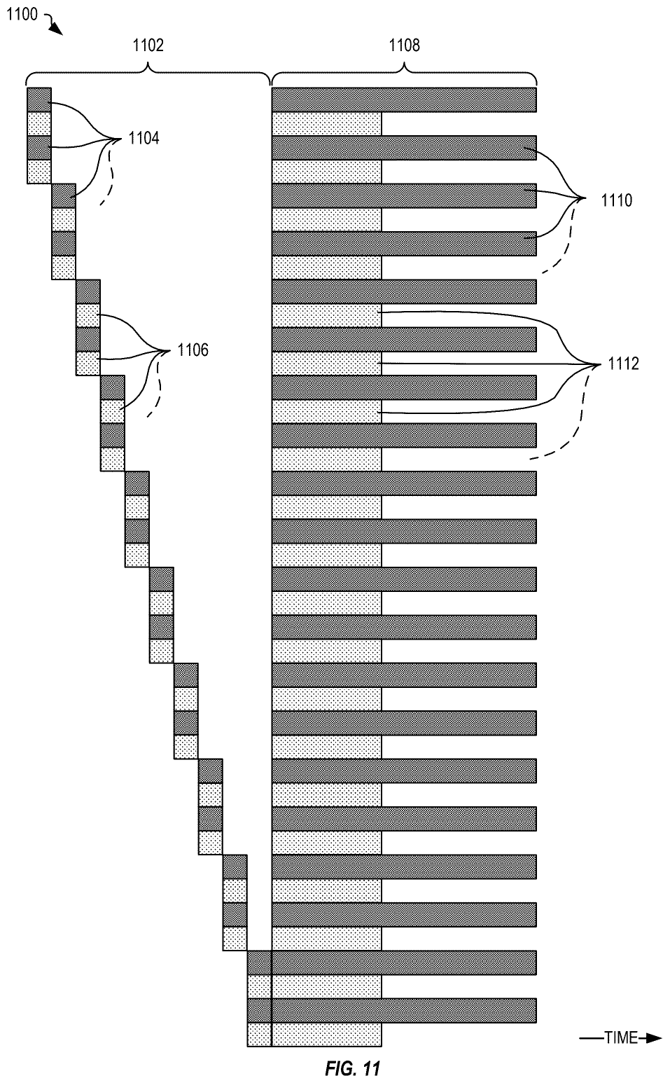

In certain embodiments, an initial ROI location may be specified by a user. ROI tracker 114 processes event data from event driven circuitry 106 and determines ROI 402/502 to includes pixels of image sensor core 102 indicated as changing. Where no events signals are generated by event driven circuitry 106, ROI 402/502 remain at the same location. ROI generator 116 is invoked to generate ROI output (e.g., see ROI partial packets 1112 of FIG. 11) based on ROI 402/502. Advantageously, by automatically determining ROI 402/502, ROI tracker 114 allows hybrid image sensor 100 to achieve high spatial resolution (e.g., 12.5M pixels), and high temporal resolution for ROI 402/502, with lower power requirements as compared to conventional image sensors. Event driven circuitry 106 and ROI tracker 114 implement ROI tracking that is fast, requires less power than CIS tracking, and enables hybrid EVS-CIS to realize smart ROI with fast tracking.

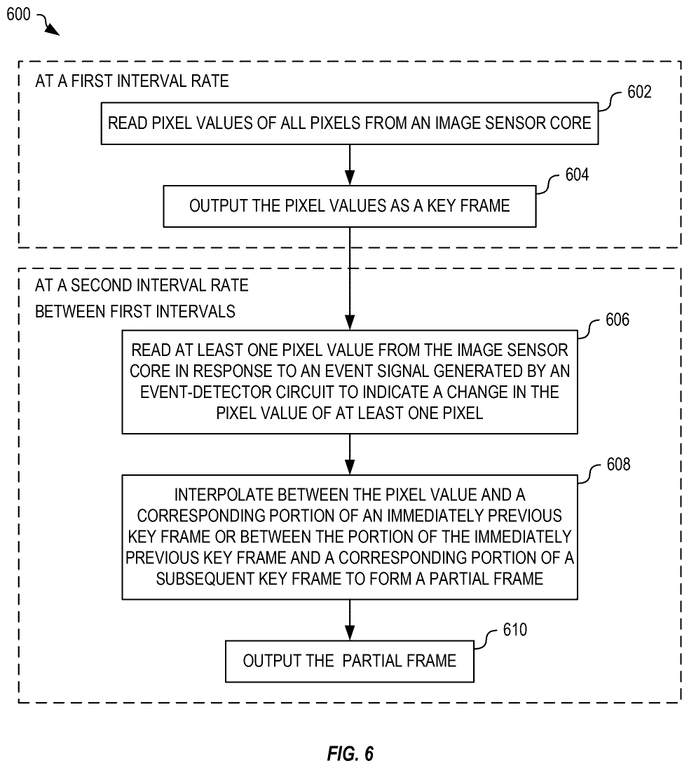

FIG. 6 is a flowchart illustrating one example method 600 for EVS based CIS FVI, in embodiments. Method 600 is implemented by image sensor 100 of FIG. 1 for example.

Blocks 602 and 604 generate key frame readout 202 of FIG. 2 and repeat at a first interval rate and blocks 606 through 610 generate interpolation frame readouts 206 and repeat at a second interval rate between the first intervals. For example, as shown in FIG. 2, three interpolation frame readouts 206 occur for each key frame readout 202.

In block 602, method 600 reads pixel values of all pixels from an image sensor core. In one example of block 602, CIS reader 108 reads all pixels of image sensor core 102. In block 604, method 600 outputs the pixel values as a key frame. In one example of block 604, image sensor processor 104 outputs the pixel values as MIPI key frame output 302 of FIG. 3.

In block 606, method 600 reads at least one pixel value from the image sensor core in response to an event signal generated by an event detector circuit to indicate a change in the pixel value of the at least one pixel. In one example of block 606, event driven circuitry 106 generates event signals 107 causing CIS reader 108 to read at least one pixel value indicated by event signals 107 from image sensor core 102. In block 608, method 600 interpolates between the pixel value and a corresponding portion of an immediately previous key frame or between the portion of the immediately previous key frame and a corresponding portion of a subsequent key frame to form a partial frame. In one example of block 608, VFI generator 112 generates at least one interpolation frame data packet 354 based on the at least one pixel value of block 606 and key frame data packets 304 corresponding to the at least one pixel indicated by event signal 107. In another example of block 608, VFI generator 112 generates at least one interpolation frame data packet 354 based on the at least one pixel value of block 606, key frame data packets 304 corresponding to the at least one pixel indicated by event signal 107, and a portion of a subsequent key frame corresponding to the at least one pixel. In block 610, method 600 outputs the partial frame. In one example of block 610, image interface 120 generates at least one interpolation frame data packets 354. Blocks 606 through 610 repeat for each event signals 107 generated by event driven circuitry 106 such that interpolation frame readout 206 occurs at the second interval rate for each first interval.

### Reading CIS VFI

CIS reader 108 may include multiple configurable options for reading pixel values from image sensor core 102 based on events generated by event driven circuitry 106. These configurable options may include: Option 1A—read out CIS pixel at location where there is EVS output; option 1B—ad out CIS pixel at location where there is EVS output and adjacent row and column, option 2A—read out CIS row at location where there is EVS output, option 2B—read out CIS row at location where there is EVS output and adjacent row, option 3A—read out CIS at location where there is EVS output and adjacent pixel that row within same column section, option 3B—read out CIS at location where there is EVS output and adjacent pixel that row within same column section and adjacent row and column, and option 3C—Similar to option 3B, but only read out CIS pixel at tracking target and adjacent pixel.

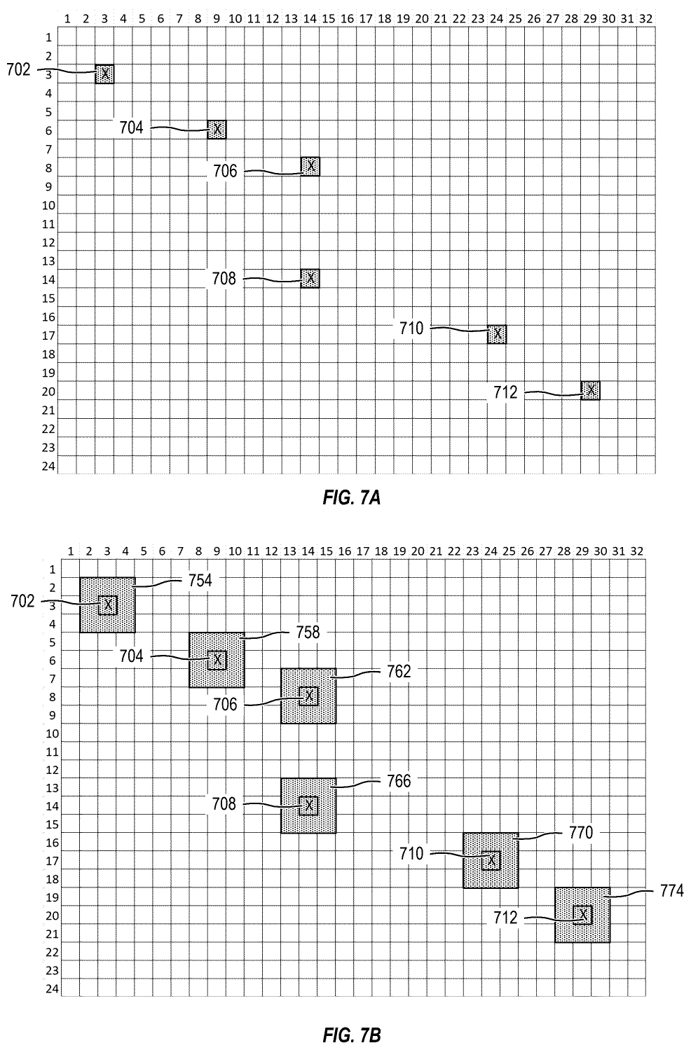

FIGS. 7A, 7B, 8A, 8B, 9A, 9B, and 10A are schematic representations of a portion of a pixel array of image sensor core 102 illustrating a plurality of events 702, 704, 706, 708, 710, and 712 generated by event driven circuitry 106 and corresponding readout areas of pixel values by CIS reader 108, in embodiments.

FIG. 7A represents option 1A where event 702 causes CIS reader 108 to read a single pixel value from pixel coordinate 3:3, event 704 causes CIS reader 108 to read a single pixel value from pixel coordinate 7:9, event 706 causes CIS reader 108 to read a single pixel value from pixel coordinate 8:14, event 708 causes CIS reader 108 to read a single pixel value from pixel coordinate 14:14, event 710 causes CIS reader 108 to read a single pixel value from pixel coordinate 17:24, and event 712 causes CIS reader 108 to read a single pixel value from pixel coordinate 20:29. Since only one pixel value is read per event, option 1A results in the lowest CIS data rate.

FIG. 7B represents option 1B where event 702 causes CIS reader 108 to read pixel values from a pixel area 754 corresponding to pixel coordinate 3:3 and adjacent pixels, event 704 causes CIS reader 108 to read pixel values from a pixel area 758 corresponding to pixel coordinate 6:9 and adjacent pixels, event 706 causes CIS reader 108 to read pixel values from a pixel area 762 corresponding to pixel coordinate 8:14 and adjacent pixels, event 708 causes CIS reader 108 to read pixel values from a pixel area 766 corresponding to pixel coordinate 14:14 and adjacent pixels, event 710 causes CIS reader 108 to read pixel values from a pixel area 770 corresponding to pixel coordinate 17:24 and adjacent pixels, and event 712 causes CIS reader 108 to read pixel values from a pixel area 774 corresponding to pixel coordinate 20:29 and adjacent pixels. Since only nine pixel values are read per event, option 2A results in the second lowest CIS data rate. Where readout of image sensor core 102 is block based, it may be more efficient to read all pixels of a block from image sensor core 102 instead of selecting individual pixels for readout from image sensor core 102.

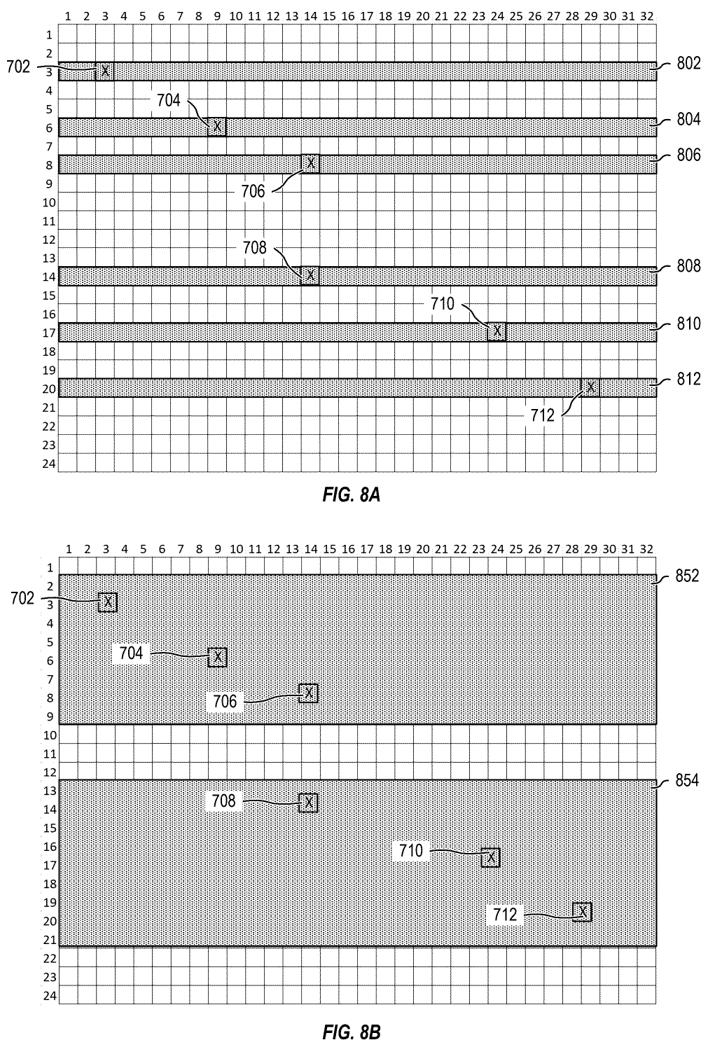

FIG. 8A represents option 2A where event 702 causes CIS reader 108 to read pixel values from a row 802 corresponding to the pixel that caused event 702, event 704 causes CIS reader 108 to read pixel values from a row 804 corresponding to the pixel that caused event 704, event 706 causes CIS reader 108 to read pixel values from a row 806 corresponding to the pixel that caused event 706, event 708 causes CIS reader 108 to read pixel values from a row 808 corresponding to the pixel that caused event 708, event 710 causes CIS reader 108 read pixel values from a row 810 corresponding to the pixel that caused event 710, and event 712 causes CIS reader 108 to read pixel values from a row 812 corresponding to the pixel that caused event 712. Option 2A has a medium CIS data rate.

FIG. 8B represents option 2B where events 702, 704, and 706 causes CIS reader 108 to read pixel values from an area 852 corresponding to rows of pixels that caused events 702, 704, and 706 and their adjacent rows, and events 708, 710, and 712 causes CIS reader 108 to read pixel values from an area 854 corresponding to rows of pixels that caused events 708, 710, and 712 and their adjacent rows. Option 2B also has a medium CIS data rate.

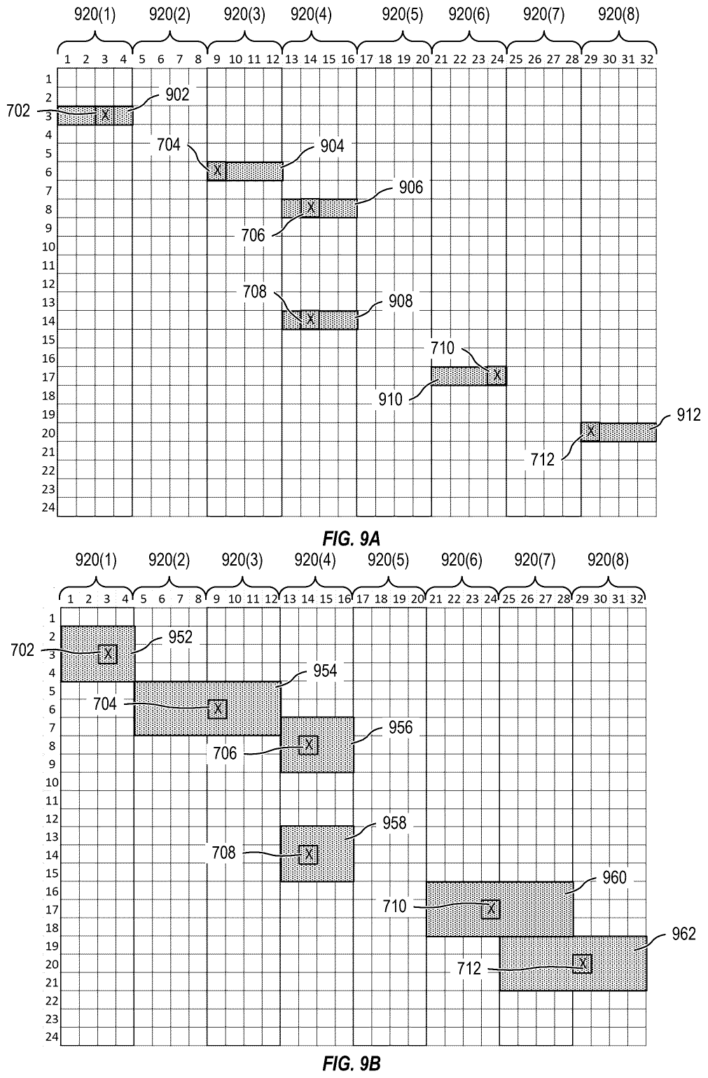

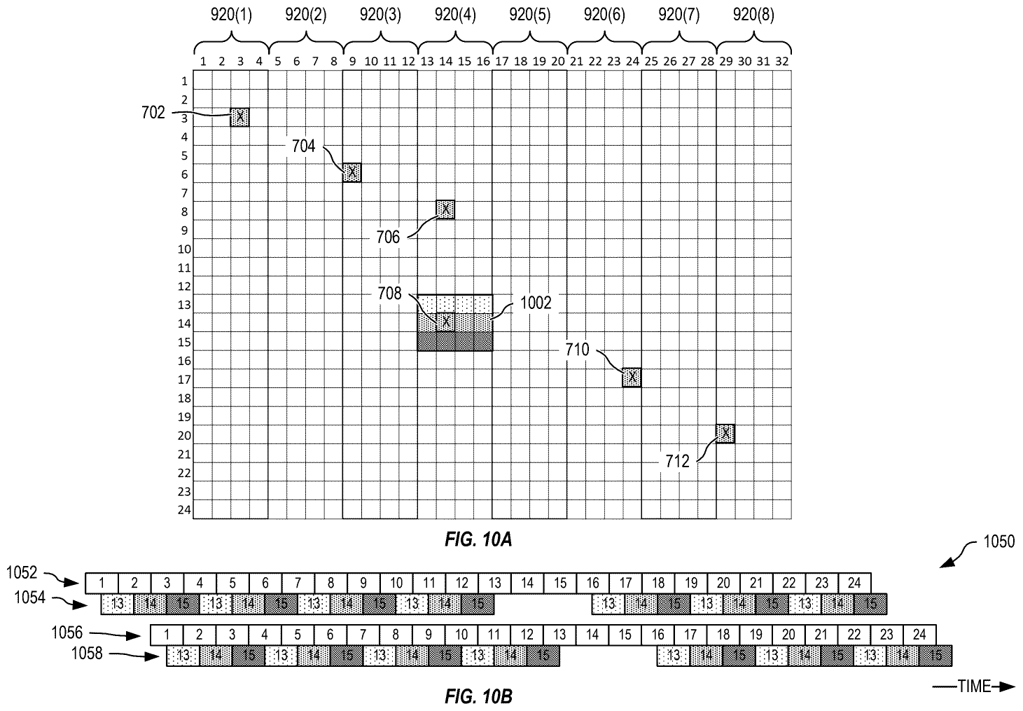

In the examples of FIGS. 9A, 9B, and 10A, which represent options 3A, 3B, and 3C respectively, the pixel array is subdivided into virtual column sections 920(1)-920(8), where each column section includes four pixel columns. In the example of FIG. 9A, event 702 causes CIS reader 108 to read pixel values from an area 902 that includes adjacent pixels within one column section for one row and selected based on the pixel location of event 702. Similarly, event 704 causes CIS reader 108 to read pixel values from an area 904, event 706 causes CIS reader 108 to read pixel values from an area 906, event 708 causes CIS reader 108 to read pixel values from an area 908, event 710 causes CIS reader 108 to read pixel values from an area 910, and event 712 causes CIS reader 108 to read pixel values from an area 912.

In the example of FIG. 9B, adjacent pixels of the events are also included, such that event 702 causes CIS reader 108 to read pixels from an area 952 formed of column sections 920 and rows needed to include pixels immediately adjacent to the pixel causing the event. For example, area 952 is formed of column section 920(1) and includes three rows (2-4). Similarly, event 704 causes CIS reader 108 to read pixels of area 954, which is formed of three rows (5-7) and two column sections 920(2) and 920(3); event 706 causes CIS reader 108 to read pixels of area 956, which is formed of three rows (7-9) and one column section 920(3); event 708 causes CIS reader 108 to read pixels of area 958, which is formed of three rows (13-15) and one column section 920(3); event 710 causes CIS reader 108 to read pixels of area 960, which is formed of three rows (16-18) and two column sections 920(6) and 920(7); and event 712 causes CIS reader 108 to read pixels of area 962, which is formed of three rows (19-21) and two column sections 920(7) and 920(8).

### Reading Smart ROI

FIG. 10A represents option 3C where ROI tracker 114 of hybrid image sensor 100 determines that event 708 represents a moving target within a field-of-view of hybrid image sensor 100 and determines an ROI area 1002 that includes the moving target. ROI area 1002 represents smart ROIs 402 and 502 of FIGS. 4 and 5, for example. In one example, the moving target imaged by image sensor core 102 is a golf ball that causes event driven circuitry 106 to generate events as the golf ball moved through the field-of-view of image sensor core 102. During key frame readout 202 the whole CIS image is read out from image sensor core 102 and output at 30 fps (frames per second), and during interpolation frame readout 206, ROI area 1002 is read out from image sensor core 102 and output at 480 fps. Advantageously, the moving target in ROI area 1002 is captured at a high frame rate, as compared to a full frame rate, and detail of the target is not lost (e.g., as occurs due to movement of the object when the frame rate of the image sensor is too slow). Further, since only a portion of the image is output at 480 fps, the bandwidth needed for the data output from hybrid image sensor 100 is significantly less than the bandwidth needed for output of full frames at 480 fps. Although shown with one event 708, ROI area 1002 may be sized to include pixels of multiple events.

FIG. 10B is a timing chart 1050 illustrating example staggering of precharge and readout operations for rows of image sensor core 102 for both full frame and ROI area 1002 of FIG. 10A, in embodiments. Timing chart 1050 shows a full frame precharge 1052 of rows 1-24 and a ROI precharge 1054 for rows 13-15 corresponding to ROI area 1002, where rows of full frame precharge 1052 are interleaved with rows of ROI precharge 1054. Timing chart 1050 also shows a full frame readout 1056 of rows 1-24 and a ROI readout 1058 for rows 13-15 of ROI area 1002, where rows of ROI readout 1058 are interleaved with rows of full frame readout 1056. For example, full frame precharge 1052 and full frame readout 1056 represent key frame readout 202 of FIG. 2 and ROI precharge 1054 and ROI readout 1058 represent interpolation frame readout 206 of FIG. 2.

In one example of the precharging operation, image sensor core 102 starts by precharging all pixels of a first full frame row (e.g., row 1) and then precharges pixels of at least a partial row corresponding to a first row of ROI area 1002 (e.g., row 13). Image sensor core 102 then precharges all pixels of a next full frame row (e.g., row 2) and then precharges pixels of at least a partial row corresponding to a next row (e.g., row 14) of ROI area 1002. Image sensor core 102 then precharges all pixels of a next full frame row (e.g., row 3) and then precharges pixels of at least a partial row corresponding to a next row of ROI area 1002 (e.g., row 15). In a next iteration, all pixels of a next full frame row (e.g., row 4) are precharged and then pixels corresponding to at least a partial row corresponding to a next row of ROI area 1002 (e.g., row 13) are precharged. This precharging sequence repeats. The repetition rate (e.g., ROI frame rate) for precharging rows of ROI area 1002 is higher than the repetition rate (e.g., full frame rate) of the full frame. The ROI precharge is skipped when the next row of ROI precharge 1054 was precharged during the immediately previous full frame precharge 1052.

Readout of each row occurs a certain time (e.g., a shutter time) after the precharge of the row and the readout sequence is similar to the precharge sequence. In one example of the readout operation, CIS reader 108 first reads out all pixels of a first full frame row (e.g., row 1) and then CIS reader 108 reads pixels of at least a partial row corresponding to a first row (e.g., row 13) of ROI area 1002. CIS reader 108 then reads all pixels of a next full frame row (e.g., row 2) and then reads pixels of at least a partial row corresponding to a next row (e.g., row 14) of ROI area 1002. CIS reader 108 then reads all pixels of a next full frame row (e.g., row 3) and then reads pixels of at least a partial row corresponding to a next row (e.g., row 15) of ROI area 1002. CIS reader 108 then reads all pixels of a next full frame row (e.g., row 4) and then reads pixels of at least a partial row corresponding to a next row (e.g., row 13) of ROI area 1002. This sequence repeats to repeatedly read out full frames from image sensor core 102 at a full frame rate, and to readout ROI area 1002 at an ROI frame rate that is greater than the full frame rate. Similarly to the precharging, readout of ROI rows that align with the full row readout are skipped and ROI readout uses pixel values from the corresponding full row readout.

FIG. 11 is a schematic diagram illustrating one example staggered key frame mode 1100 that includes staggered key readout frame 1102 and a corresponding MIPI staggered frame output 1108, in embodiments. Staggered key readout frame 1102 is implemented by CIS reader 108 of FIG. 1, with full row readout periods 1104 and ROI partial row readout periods 1106 of pixel data from image sensor core 102. MIPI staggered frame output 1108 includes full frame packets 1110 generated by full row readout periods 1104 that are interleaved with ROI partial packets 1112 generated by ROI partial row readout periods 1106. During staggered frame mode 1100, full frame packets 1110 form a key frame that includes all CIS pixel data of a full image frame. ROI partial packets 1112 includes CIS pixel data for only an ROI area (e.g., ROI area 1002 of FIG. 10A) and the ROI area may be updated multiple time during one example staggered frame mode 1100.

Advantageously, ROI area 1002 is updated in real-time based on EVS information (e.g., events 702-712 of FIG. 7A) detected by event driven circuitry 106. Prior-art CIS tracking of a target requires subtraction of two image frames to determine movement information, which is significantly slower and requires more power as compared to event driven circuitry 106 and ROI tracker 114. Advantageously, event driven circuitry 106 detects signal change in pixels of image sensor core 102 that correspond to changes in a corresponding field-of-view captured by image sensor core 102 caused by movement of a target object for example, and the generated events may correspond to the movement of the target object. ROI tracker 114 implements at least one algorithm to process the events and track movement of the target without requiring subtraction. Event driven circuitry 106 is low latency and ROI tracker 114 is fast and low powered in comparison to conventional CIS tracking.

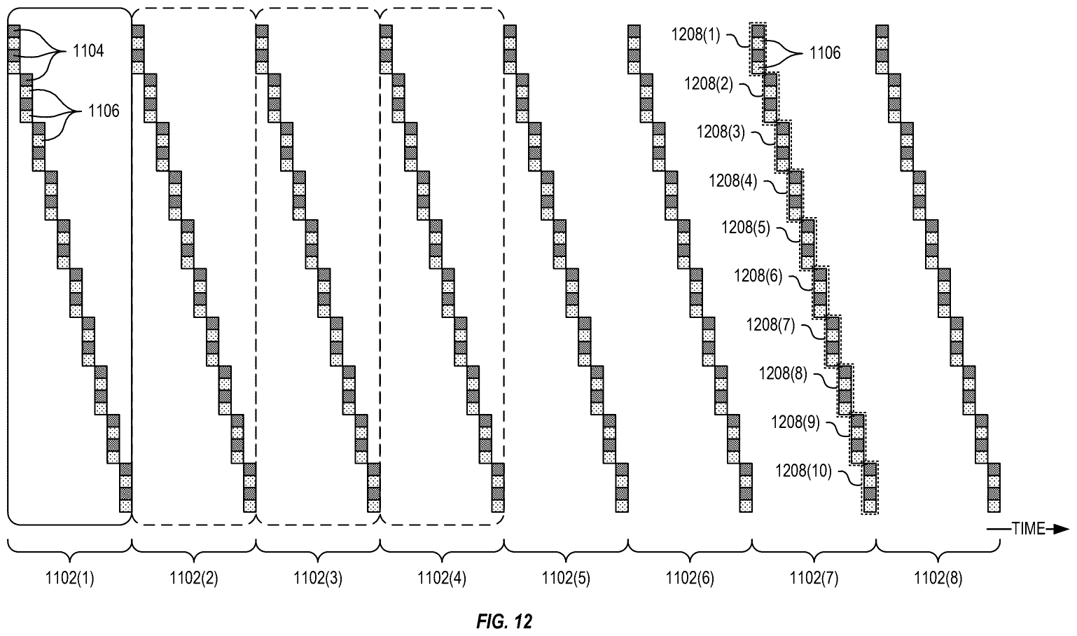

FIG. 12 is a schematic diagram showing a plurality of staggered key readout frames 1102 of FIG. 11 where each staggered key readout frame 1102 includes multiple example CIS ROI frames 1208, in embodiments. FIG. 12 follows the example of FIG. 11 and shows staggered key readout frames 1102(1)-1102(8) including interleaved full row readout periods 1104 and ROI partial row readout periods 1106. The size of CIS ROI frame 1208 depends on a size (e.g., number of pixel rows) of ROI area 1002, and the number of CIS ROI frames 1208 output during one staggered key readout frame 1102(7) depends on the size of ROI area 1002. In the example of FIG. 12, each CIS ROI frame 1208 requires two ROI partial row readout periods 1106 and ten CIS ROI frames 1208(1)-1208(10) occur during one staggered key readout frame 1102(7) as shown. Accordingly, a frame rate of CIS ROI frames 1208 depends on a size of ROI area 1002, which is automatically determined by ROI tracker 114 based on events (e.g., events 702-712, FIG. 7A) generated by event driven circuitry 106. Accordingly, the size and frame rate of CIS ROI frame 1208 is dynamic.

### Combination of CIS VFI and Stagger ROI

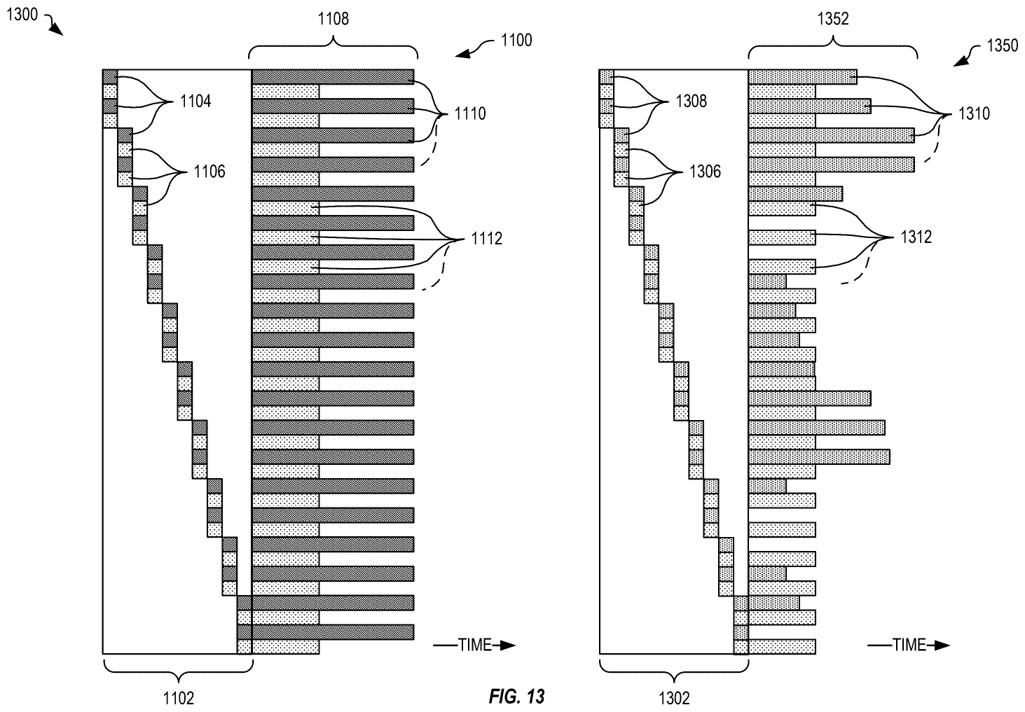

FIG. 13 is a schematic diagram illustrating one example staggered interpolation mode 1300 of hybrid image sensor 100 of FIG. 1, in embodiments. Staggered interpolation mode 1300 combines staggered frame mode 1100 of FIG. 11 with a staggered interpolation frame mode 1350 that includes interpolation readout periods 1308 that are similar to rolling shutter interpolation periods 208 of FIGS. 2 and 3, but are interleaved with ROI partial row readout period 1306 that are similar to ROI partial row readout periods 1106 of staggered frame mode 1100. That is, ROI partial row readout periods 1306 and interpolation readout periods 1308 are interleaved in staggered interpolation readout frames 1302, where staggered interpolation readout frames 1302 follows staggered key readout frame 1102. Interpolation readout periods 1308 generate interpolation frame data packets 1310 that are similar to interpolation frame data packets 354 of FIG. 3. Particularly, interpolation frame data packets 1310 are only generated in response to event signals 107 from event driven circuitry 106.

ROI partial row readout period 1306 are similar to ROI partial row readout periods 1106 and result in generation of ROI partial packets 1312 that are similar to ROI partial packets 1112, and interpolation readout periods 1308 result in interpolation frame data packets 1310, where interpolation frame data packets 1310 and ROI partial packets 1312 are interleaved to form MIPI interpolation frame output 1352.

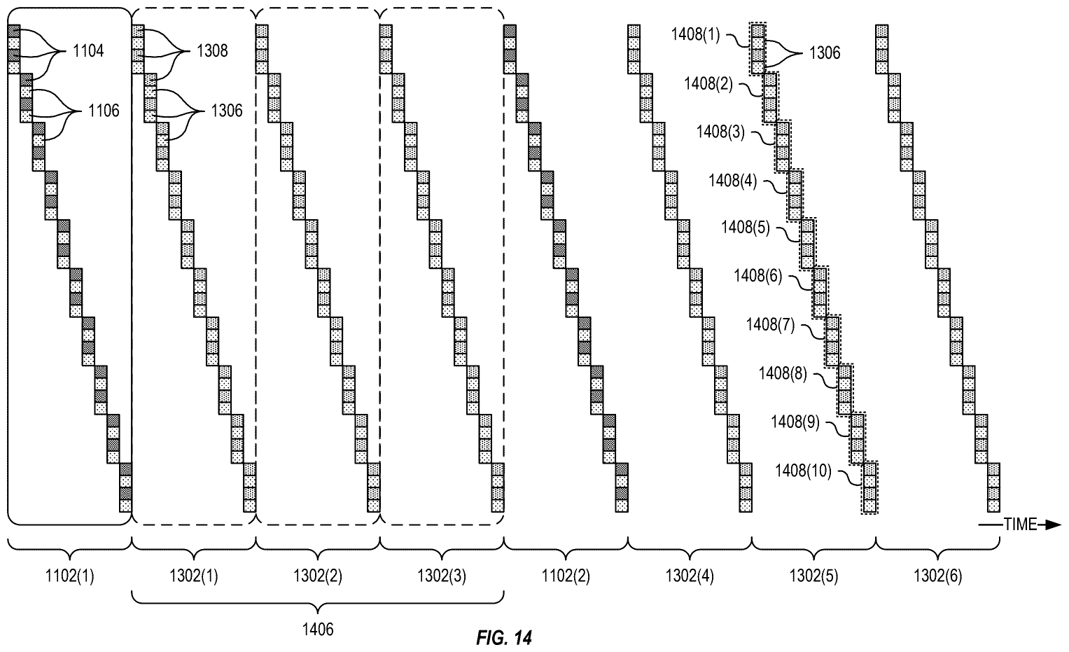

FIG. 14 is a schematic diagram illustrating a sequence of staggered key readout frames 1102 and staggered interpolation readout frames 1302 where one staggered interpolation readout frame 1302 includes multiple ROI readout frames 1408. A plurality 1406 of staggered interpolation readout frames 1302 are generated and output between each staggered key readout frame 1102. ROI readout frame 1408 represents the readouts from image sensor core 102 needed to complete ROI area 1002. As discussed above, this is dependent on the size of ROI area 1002 and may therefore vary over time. Each staggered key readout frame 1102 represents a key frame that output s all CIS pixel data for one image frame. Each staggered interpolation readout frame 1302 outputs CIS pixel data of a partial image frame. Each ROI readout frame 1408 outputs a partial image frame corresponding to ROI area 1002.

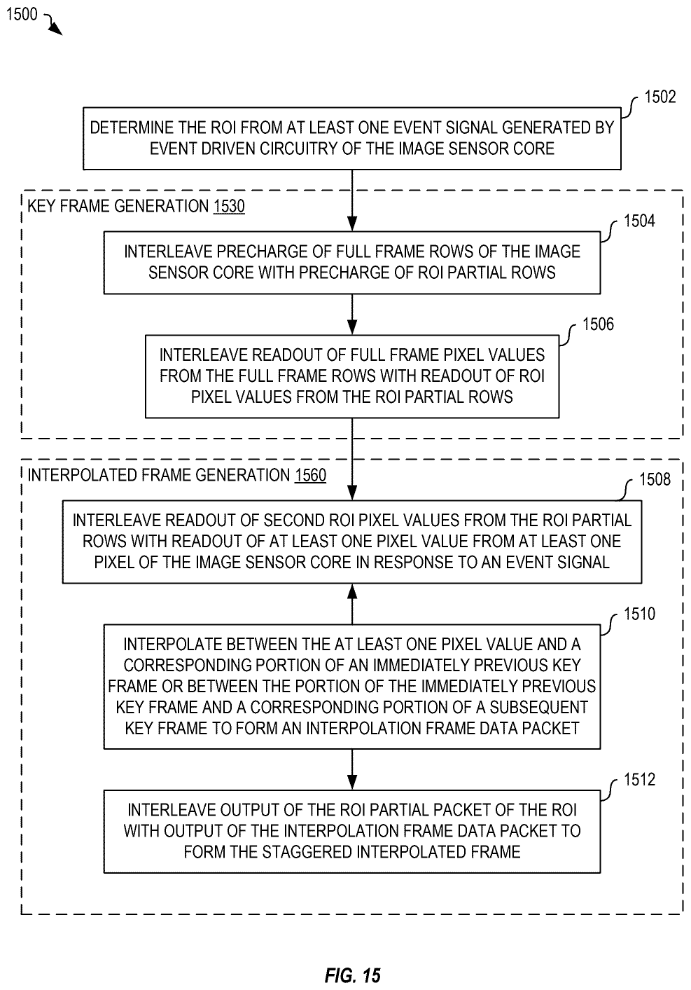

FIG. 15 is a flowchart illustrating one example method 1500 for combined CIS VFI and Staggered ROI, in embodiments. Method 1500 is implemented in image sensor processor 104 of hybrid image sensor 100 of FIG. 1, for example. Block 1502 through block 1506 implement key frame generation 1530 and block 1508 through block 1512 implement interpolated frame generation 1560.

In block 1502, method 1500 determines the ROI from at least one event signal generated by event driven circuitry of the image sensor core. In one example of block 1502, ROI tracker 114 processes event signals 107 to determine ROI area 1002.

In block 1504, method 1500 interleaves precharge of full frame rows of the image sensor core with precharge of ROI partial rows. In one example of block 1504, image sensor processor 104 interleaves full frame precharge 1052 with ROI precharge 1054.

In block 1506, method 1500 interleave readout of full frame pixel values from the full frame rows with readout of ROI pixel values from the ROI partial rows. In one example of block 1506, image sensor processor 104 interleaves full frame readout 1056 with ROI readout 1058.

In block 1508, method 1500 interleave readout of second ROI pixel values from the ROI partial rows with readout of at least one pixel value from at least one pixel of the image sensor core in response to an event signal. In one example of block 1508, image sensor processor 104 interleaves readout of at least one pixel value indicated by event signals 107 from image sensor core 102 with readout of at least partial rows of ROI area 1002.

In block 1510, method 1500 interpolates between a corresponding portion of an immediately previous key frame and the at least one pixel value or between the corresponding portion of the immediately previous key frame and a corresponding portion of a subsequent key frame to form an interpolation frame data packet. In one example of block 1510, CIS reader 108 reads at least one pixel value indicated by event signals 107 from image sensor core 102 and VFI generator 112 generates at least one interpolation frame data packet 354 based on the at least one pixel value and key frame data packets 304 corresponding to the at least one pixel indicated by event signal 107. In another example of block 1510, CIS reader 108 reads at least one pixel value indicated by event signals 107 from image sensor core 102 and VFI generator 112 generates at least one interpolation frame data packet 354 based on the at least one pixel value, key frame data packets 304 corresponding to the at least one pixel indicated by event signal 107, and key frame data packets of a subsequent key frame corresponding to the at least one pixel indicated by event signal 107.

In block 1512, method 1500 interleave output of the ROI partial packet of the ROI with output of the interpolation frame data packet to form the staggered interpolated frame. In one example of block 1512, image sensor processor 104 interleaves interpolation frame data packets 1310 with ROI partial packets 1312 to form MIPI interpolation frame output 1352 for staggered interpolation frame mode 1350.

Block 1508 through block 1512 may repeat more often than block 1504 through block 1506 where interpolated frame generation 1560 occurs multiple times for each key frame generation 1530. In the example of FIG. 14, interpolated frame generation 1560 occurs three times between each key frame generation 1530.

### Phase Detection Autofocus

Hybrid image sensor 100 may also implement phase detection autofocus (PDAF) to allow fast and accurate focusing of a lens apparatus. Image sensor core 102 may include PDAF pixels distributed over its imaging area that are specifically designated for phase detection. For example, the PDAF pixels may be masked to only receive light from one side of a lens and thereby forming two sets of images: one from the left and one from the right. For conventional PDAF processing, an image processor compares the two sets of PDAF pixels for the entire imaging area to determine a phase difference, which indicates whether the image is in focus or not. The phase difference is then used to determine a lens movement to achieve focus. Conventional PDAF is particularly effective for tracking moving subjects whereby the processor continuously processes all PDAF pixels to measure the phase difference to allow the lens position to be adjusted in real-time, ensuring that the subject remains in focus even if it moves.

Hybrid image sensor 100 also includes PDAF pixels 103 distributed across image sensor core 102; however, image sensor processor 104 implements ROI PDAF 109 to determine a phase difference 111 for PDAF pixels 103 within the ROI indicated by ROI generator 116. Advantageously, since ROI PDAF 109 is processing fewer PDAF pixels 103, ROI PDAF 109 uses less power to generate phase difference 111 as compared to conventional full-frame PDAF.

### Combination of EVS and GS Sensor

Although the above examples show a rolling shutter implementation of image sensor core 102, the above embodiments may also apply to a GS image sensor core. For example, EVS may be used with a GS image sensor to realize CIS VFI, smart ROI, and/or a combination of both.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method for event-based imaging and video frame interpolation on a complementary metal oxide semiconductor (CMOS) image sensor core, comprising:
generating a key frame by reading pixel values of pixels from the image sensor core; and
generating an interpolated event guided low power (ELP) frame by:
reading pixel values from a pixel area of the image sensor core identified by an event signal; and
interpolating between the pixel values and a corresponding portion of the key frame or between the portion of the key frame and a corresponding portion of a subsequent key frame to form an interpolated partial frame.

2. The method of claim 1, wherein the event signal is generated by event driven circuitry on detecting a change in a pixel value of a pixel of the image sensor core.

3. The method of claim 1, wherein the pixel area only includes pixels identified by the event signal.

4. The method of claim 3, wherein the pixel area further includes pixels adjacent to the pixels identified by the event signal.

5. The method of claim 1, wherein the pixel area includes a row of pixels of the image sensor core that includes the pixels identified by the event signal.

6. The method of claim 5, wherein the pixel area further includes rows of pixels of the image sensor core that include a pixel adjacent to at least one of the pixels identified by the event signal.

7. The method of claim 1, wherein columns of the image sensor core are formed into a plurality of column sections, the pixel area including pixels of one row of one column section of the plurality of column sections that includes the pixels identified by the event signal.

8. The method of claim 7, the pixel area further including pixels of rows of column sections of the plurality of column sections that include a pixel adjacent to the pixels identified by the event signal.

9. A method for event-based imaging with a complementary metal oxide semiconductor (CMOS) image sensor core and a region of interest (ROI), comprising:
determining the ROI from at least one event signal generated by event driven circuitry of the image sensor core; and
generating a key frame by:
interleaving precharge of full frame rows of the image sensor core with precharge of ROI partial rows of the ROI; and
interleaving readout of full frame pixel values from the full frame rows with readout of ROI pixel values from the ROI partial rows.

10. The method of claim 9, wherein phase detection autofocus (PDAF) is performed using only PDAF pixels within the ROI.

11. The method of claim 9, further comprising:
outputting the full frame pixel values as a full frame packet of the key frame; and
outputting the ROI pixel values as an ROI partial packet of the ROI;
wherein the full frame packets and the ROI partial packets are interleaved.

12. The method of claim 11, further comprising:
generating a staggered interpolated event guided low power (ELP) frame by:
interleaving readout of second ROI pixel values from the ROI partial rows with readout of at least one pixel value from at least one pixel of the image sensor core in response to an event signal;
interpolating between the at least one pixel value and a corresponding portion of an immediately previous key frame or between the portion of the immediately previous key frame and a corresponding portion of a subsequent key frame to form an interpolation frame data packet; and
interleaving output of the ROI partial packet of the ROI with output of the interpolation frame data packet to form the staggered interpolated ELP frame.

13. The method of claim 9, wherein the ROI has an ROI frame rate that is higher than a full frame rate of the CMOS image sensor core.

14. The method of claim 9, further comprising updating the ROI based on event signals generated by the event driven circuitry.

15. The method of claim 9, the at least one event signal indicating a change in a pixel value of at least one pixel of the image sensor core.

16. A complementary metal oxide semiconductor (CMOS) image sensor, comprising:
an image sensor core having a plurality of image sensing pixels;
event driven circuitry for generating an event signal indicating at least one pixel of the image sensor core having a changed pixel value; and
a processor coupled with the image sensor core and implementing:
a CMOS image sensor (CIS) reader for reading pixel values from the image sensing pixels of the image sensor core;
a key frame generator for controlling the CIS reader to read pixel values to form a key frame; and
a video frame interpolator for controlling the CIS reader to read pixel values of a pixel area corresponding to an event to form an interpolated frame based on a previous key frame and one of (a) the pixel values and (b) a subsequent key frame.

17. The CMOS image sensor of claim 16, the processor further implementing the video frame interpolator to interpolate between a corresponding portion of the key frame, pixel values of the pixel area, and a corresponding portion of a subsequent key frame to form the interpolated frame.

18. The CMOS image sensor of claim 16, wherein the pixel area includes the at least one pixel and adjacent pixels.

19. The CMOS image sensor of claim 16, wherein the pixel are includes a row of pixels of the image sensor core that includes the at least one pixel.

20. The CMOS image sensor of claim 16, wherein the pixel are includes a row of pixels of the image sensor core that includes the at least one pixel and adjacent rows of pixels.

21. The CMOS image sensor of claim 16, wherein columns of the image sensor core are formed into a plurality of column sections, the pixel area including pixels of one row of one column section of the plurality of column sections that includes the at least one pixel.

22. The CMOS image sensor of claim 16, wherein columns of the image sensor core are formed into a plurality of column sections, the pixel are including pixels of rows of column sections of the plurality of column sections that include the at least one pixel or pixels adjacent to the at least one pixel.

23. The CMOS image sensor of claim 16, the processor further implementing:
a region of interest (ROI) tracker for determining an ROI of the image sensor core based on the event signal; and
an ROI generator for controlling the CIS reader to read pixel values identified by the event signal to form an ROI frame.

24. The CMOS image sensor of claim 23, the processor further generating a phase difference for phase detection autofocus (PDAF) using only PDAF pixels within the ROI.
